(19) United States
(12) Patent Application Publication
(10) Pub. No.: US 2001/0054855 A1
(43) Pub. Date: Dec. 27, 2001

(54) Electric motor

(76) Inventors: Karl Echtler, Puchheim (DE); Andreas Degmayr, Munchen (DE)

Correspondence Address: BROWN & WOOD LLP, One World Trade Center, New York, NY, 10048-0557, US

(21) Appl. No.: 09/821,560

(22) Filed: Mar. 29, 2001

(30) Foreign Application Priority Data
Mar. 30, 2000 (DE) 100 15 924.9

(51) Int. Cl. H02K 1/06

(52) U.S. Cl. 310/216; 310/254

(57) ABSTRACT

An electric motor having a commutator and alternating rotating direction, preferably serving as a drive for hand-operated electric tools, having a groove in an axis of symmetry of the stator to prevent the armature cross field and to increase the life of the brushes, wherein the commutator is advantageously arranged symmetric thereto.

### FIELD OF THE INVENTION

The invention is directed to an electric motor operated with a commutator, preferably a series-wound enclosed-ventilated universal motor with a high power density, particularly as a drive for hand-operated electric tool equipment.

### BACKGROUND OF THE INVENTION

Electric motors of this kind comprise a rotor, which rotates about the axis of rotation and which is constructed as an armature and is provided with a current-carrying armature winding around the teeth, and a stator that surrounds the teeth like a casing and that includes a current-carrying stator winding for generating an exciting field as part of the resultant magnetic field. The armature winding, which is arranged around the teeth, is located between the magnetic poles of the magnetic field and is penetrated by the magnetic field via the pole shoes of the stator, the air gap and the teeth of the rotor.

A commutator that switches the base points of the armature windings during the rotation of the rotor ensures that the surface of the armature winding is always approximately at right angles to the direction of the magnetic field generated by the stator winding. The torque driving the rotor of the electric motor is generated with respect to the stator by the force exerted on a current-carrying conductor, via the magnetic field. The magnetic field of the stator winding, as exciting field, penetrates the armature winding principally along the pole shoes, which are insulated relative to one another, in order to prevent eddy current losses and are usually made of dynamo sheet laminations, wherein a high magnetic induction occurs in these pole shoes.

The current flowing through the armature winding is split into two parts in the commutator comprising laminations and brushes, these parts flowing around the armature in such a way that the armature is magnetized at right angles to the exciting field of the stator winding. This parasitic magnetic field, known as cross induction or armature cross field, is superposed on the exciting field. The resultant magnetic field is shifted by an acute angle relative to the exciting field, as is the neutral zone at right angles to the exciting field, in which neutral zone no reactance voltage is induced.

Because of the occasionally conducting bridging of two laminations by a brush, a reactance voltage occurs when this short circuit is interrupted by means of the resultant magnetic field; this reactance voltage causes the commutator sparking. In order to achieve a currentless switchover for non-sparking operation and accordingly minimum wear on the brushes, the brushes are arranged, via a switching displacement, in the neutral zone which is given in relation to the resultant total field and which forms a finite angle to the exciting winding. The arrangement of the brushes of the commutator is accordingly no longer axially symmetric with respect to the direction of the exciting field, so that there is no optimal operation in either rotating direction.

Alternatively, it is known to rotate the axis of the exciting field about asymmetric pole feet relative to the commutator which is arranged symmetrically in the stator by means of partial exciter windings which are constructed in multiple parts and are interconnected depending on the mode of operation (drive, braking). Electric motors of this kind are already known, for example, from DE19636519. A disadvantage in this type of electric motor which is asymmetric with respect to the axis of symmetry of the exciting field is that it can only be operated in one rotating direction with minimum brush wear. In addition, as opposed to the electric motor of identical characteristics without switching displacement, disadvantageous winding matching is required by means of a higher number of turns of the rotor.

Electric motors whose rotating direction changes approximately in equal parts and which are used, for instance, as drives for screwing tools are therefore constructed symmetrically with respect to the arrangement of the brushes and poles; however, this results in greater wear of the brushes relative to identical asymmetric electric motors operated in a single rotating direction. A possibility for limiting wear by means of a sufficient commutation in both rotating directions is given in the multiple-part construction and interconnection of the exciter windings around the pole shoes of the stator as is shown in DE-OS 1563022. Such solutions are disadvantageous particularly due to the higher manufacturing expenditure entailed by them and the additional necessary parts of the exciter winding which are not utilized in a certain type of operation.

As a result of the high magnetic saturation of the teeth of the armature in the higher output range, these teeth are in the nonlinear performance characteristic range, so that there is a weakening of the exciting field, known as armature reaction, due to the resultant magnetic field which is accordingly limited. Under shock-like loading as necessitated, for example, in screwing processes, this leads to a magnetic field weakening shock which threatens the stability of the electric motor. In order to keep the armature reaction within permissible limits, the air gap between the pole shoes and the teeth is usually increased; however, this necessitates stronger excitation and accordingly reduces efficiency.

A method for eliminating the armature cross field is to arrange compensation windings, known as auxiliary or commutating poles, at right angles to the exciter winding in addition. The compensation winding and the armature winding are in counter-series with respect to the current flow, so that there is always compensation. However, for technical reasons relating to manufacture, only large electric motors are outfitted with commutating poles of this type because it is hardly feasible in terms of technique to arrange commutating poles in small, enclosed-ventilated universal motors with high power density. Therefore, this solution is not suitable for hand-operated drives or, consequently, for small, light electric motors.

### SUMMARY OF THE INVENTION

It is the object of the invention to increase the brush life for electric motors which have commutators and are operated in both rotating directions by improving the commutating behavior, particularly by reducing the brush spark generated by the armature cross field in electric motors with commutator brushes arranged symmetric to the axis of the exciting field or stator. In particular, this is to be realized advantageously with respect to manufacturing technique in small, light electric motors.

This object is met by the independent claims. Advantageous further developments result from the dependent claims. For this object to be met, it is essential to form a groove between the pole shoes of the stator parallel to the direction of the exciting field which, with respect to material, has a lower permeability or saturation than the stator. This groove extends parallel with respect to the exciting field and therefore has practically no effect on the latter, but is in series with respect to the armature cross field having negative results on the commutation behavior and considerably weakens this armature cross field. Accordingly, the armature cross field as well as the armature reaction connected with this are appreciably reduced compared with a stator without a groove. In this way, the commutation behavior is improved and brush life is increased.

Since this solution for compensating the armature cross field is also applicable in electric motors operated in both rotating directions and in electric motors without commutating poles, this solution is suitable particularly for small, light electric motors. In addition, no winding matching is necessary compared with an electric motor without a groove.

The advantageous reduction in the armature reaction achieved through the reduction in the armature cross field reduces the risk of field weakness shocks under shock-like loading such as occurs particularly in the driving of screwing equipment.

The open groove which is normally filled with air can also advantageously be filled with another, non-ferromagnetic, nonisotropically conducting material, for example, plastic material, in order to prevent the groove being clogged by loose material.

### BRIEF DESCRIPTION OF THE DRAWINGS

The invention is described more fully in the following description with reference to the drawings.

FIG. 1 shows an electric motor with a groove and the field pattern of the magnetic induction of the magnetic field;

FIG. 2 shows a comparison of the armature cross field with and without a groove.

### DETAILED DESCRIPTION OF INVENTION

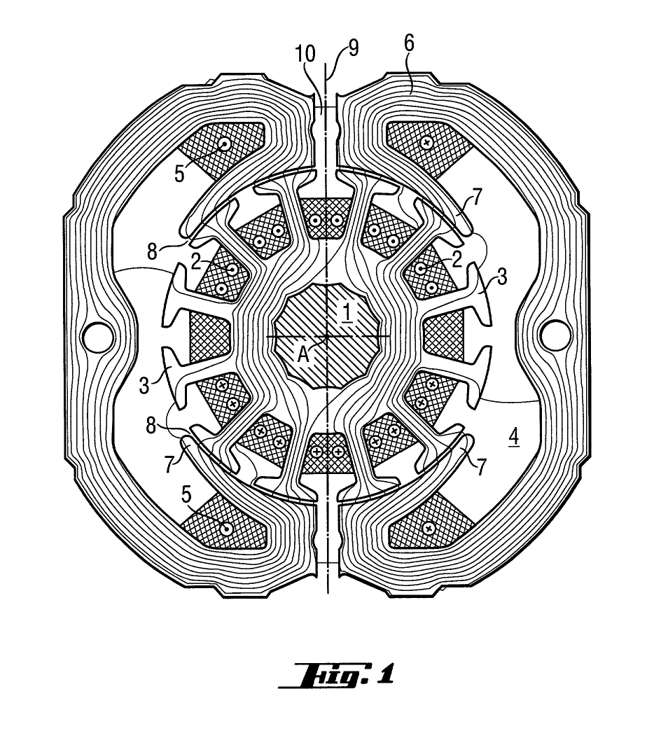

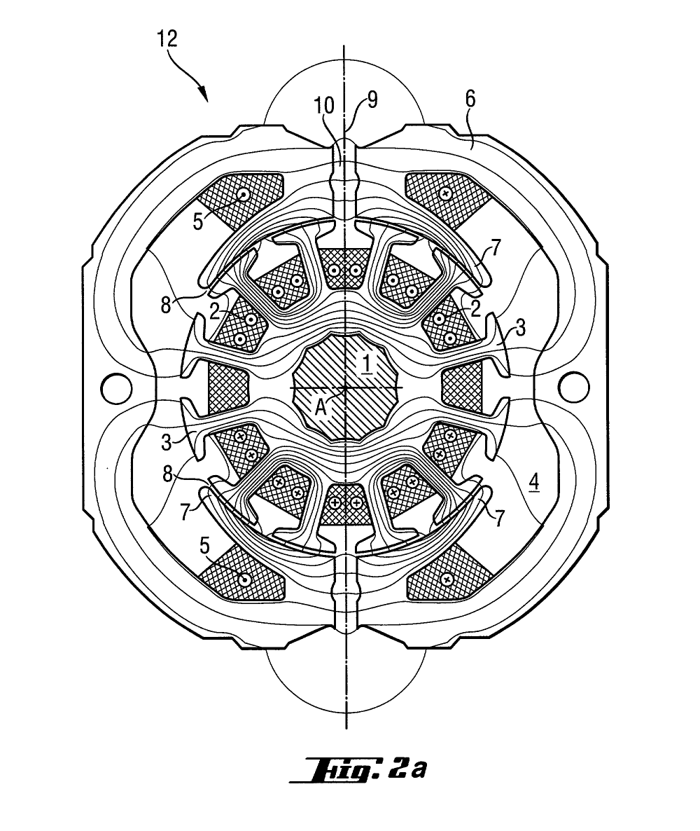

Referring to FIG. 1, an electric motor comprises a rotor 1, which rotates about an axis of rotation A and which is constructed as an armature and is provided with a current-carrying armature winding 2 around teeth 3, and a stator 4, which surrounds the teeth 3 in the manner of a casing and which has a current-carrying stator winding 5 for generating an exciting field as part of a resultant magnetic field 6. The armature winding 2, which is arranged around the teeth 3, is located between the magnetic poles of the magnetic field 6 and is penetrated by the magnetic field 6 via pole shoes 7, of the stator 4, via an air gap 8 and via the teeth 3 of the rotor 1. Inside the pole center situated in an axis of symmetry 9 of the exciting field, the stator 4 forms an at least partially continuous groove 10, which is identically constructed at both poles and which is filled with air or another non-ferromagnetic material. Such an arrangement has no influence, or no substantial influence, on the exciting field, but substantially weakens the field components of the resultant magnetic field 6, which extend at right angles to the axis of symmetry 9. Advantageously, the width of the groove 10 is a multiple of the width of the air gap 8 and accordingly, depending on the actual dimensioning, is on the order of magnitude of several mm.

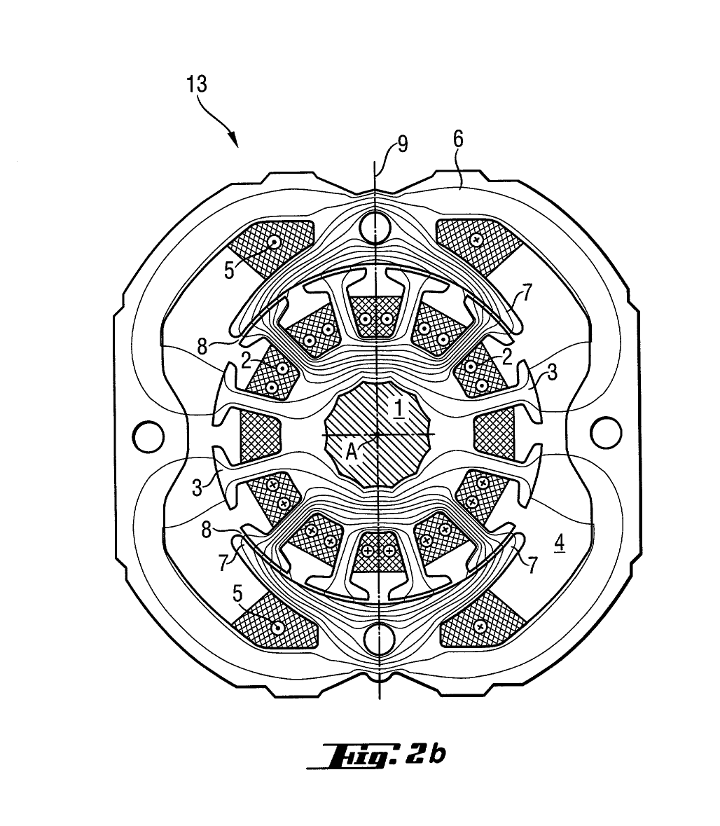

In FIG. 2, the field pattern of the magnetic induction of the armature cross field to be suppressed is compared for an electric motor 12, according to the invention, with groove 10 and an identically designed prior art electric motor 13 without groove 10. According to the invention, the armature cross field, extending at right angles to the axis of symmetry 9 in the electric motor 12 with groove 10, is substantially weaker. Accordingly, the disadvantageous consequences brought about by the armature cross field are substantially reduced even when the electric motor is constructed symmetrically to the axis of symmetry 9. In particular, the commutation behavior is improved and the brush life is, therefore, increased. Due to the symmetric construction, this advantage results equally for both rotating directions. Since the electric motor 12 with groove 10, according to the invention, makes do without commutating poles, it is particularly advantageous with respect to manufacturing techniques for small, light electric motors which are used, for example, in hand-operated drives for screwing tool equipment.

An FEM simulation calculation for concrete dimensions of an electric motor confirms the reduction in the armature cross field through a groove filled with air with a width of 2.5 mm for both limit positions of the rotor.

| Armature cross field (μVs) | with groove | without groove |
|---|---|---|
| Tooth in pole center | 190.6 | 470.1 |
| Armature winding in pole center | 127.1 | 492.1 |

What is claimed is:

1. An electric motor with a commutator comprising a rotor that rotates about an axis of rotation A and that is constructed as an armature and is provided with a current-carrying armature winding; and a stator that surrounds the winding in the form of a casing, for generating an exciting field as part of a magnetic field, wherein the stator forms an at least partially continuous groove in an axis of symmetry of the exciting field, and wherein the groove has at least one of a lower permeability and a lower saturation than the stator.

2. The electric motor of claim 1, wherein the groove has an identical geometry at both poles.

3. The electric motor of claim, wherein the commutator is arranged at right angles to the axis of symmetry.

4. The electric motor of claim 1, wherein the electric motor is constructed symmetrically with respect to the axis of symmetry.

5. The electric motor of claim 1, wherein the groove is constructed continuously along the axis of symmetry.

6. The electric motor according to claim 1, wherein the groove is filled with a non-ferromagnetic material.

7. The electric motor of claim 1, wherein the width of the groove is a multiple of the width of the air gap.

8. The electric motor of claim 1, wherein the electric motor has no commutating poles.

9. Use of the electric motor of claim 1 in a hand-operated electric tool equipment, which is series woundable.

10. Use of the electric motor of claim 9 for electric tool equipment with alternating rotating direction.
